(19) United States
(12) Patent Application Publication
(10) Pub. No.: US 2019/0210622 A1
(43) Pub. Date: Jul. 11, 2019

(54) SYSTEM, PREDICTION UNIT, AND METHOD FOR PREDICTING A FAILURE OF AT LEAST ONE UNIT FOR MONITORING AND/OR CONTROLLING TRANSPORTATION TRAFFIC

(71) Applicant: SIEMENS MOBILITY GMBH, MUENCHEN (DE)

(72) Inventors: MARTIN FANKHAUSER, BRUCK (AT); BENNY KNEISSL, MARKT SCHWABEN (DE); TIAGO RAMOS, VIANA DO CASTELO (PT)

(21) Appl. No.: 16/334,440

(22) PCT Filed: Sep. 15, 2017
(86) PCT No.: PCT/EP2017/073244

§ 371 Date: Mar. 19, 2019

(30) Foreign Application Priority Data
Sep. 19, 2016 (EP) 16189436.5

(51) Int. Cl. B61L 27/00; G06N 5/04

(52) U.S. Cl. CPC B61L 27/0088; G06N 5/046; B61L 27/0005

(57) ABSTRACT

A system, a prediction unit, and a method for predicting a failure of at least one unit for monitoring and/or controlling transportation traffic. The system includes a communication network having at least one network access point, a functional unit dedicated to the at least one unit for monitoring and/or controlling transportation traffic, wherein the decentralized functional unit is connected to the at least one network access point, and a prediction unit configured to predict the failure based on data sent from the functional unit and/or received by the functional unit over the communication network.

The invention relates to a system, prediction unit, and method for predicting a failure of at least one unit for monitoring and/or controlling transportation traffic.

With regard to railroad switches, it is known that a point machine is equipped with a sensor measuring the electrical power to be applied to the railroad switch during a toggle (transition from a first switch state to a second switch state). Based on the measured electrical power (which is strongly correlated with the applied force) it is possible to determine the condition of the railroad switch. However, the known method requires additional cabling, sensors, and continuous data transmission resulting in relatively high hardware costs and additional failure sources. In particular, the data access to the railroad switch resulting from such a solution will involve a security issue.

It is an object of the invention to provide a system for predicting the failure of at least one unit for monitoring and/or controlling transportation traffic, which is simplified compared to known systems, in particular regarding implementation, maintenance, hardware effort, and security.

This object is solved by a system for predicting a failure of at least one unit for monitoring and/or controlling transportation traffic, comprising: a communication network having at least one network access point, a functional unit dedicated to the at least one unit for monitoring and/or controlling transportation traffic, wherein the functional unit is connected to the at least one network access point, and a prediction unit configured to predict the failure based on data sent from the functional unit and/or received by the functional unit over the communication network.

The invention is based on the finding that failures of units for monitoring and/or controlling transportation traffic cause expensive delays in the traffic. However, the known solutions entail high hardware costs and additional failure sources. In contrast to the known solutions, the present invention makes a prediction of the failure possible solely on data captured from the communication output from or input to the functional unit.

The term “unit for controlling transportation traffic” can also be referred to as “traffic-influencing unit”. The term “transportation traffic” may preferably be understood as traffic of transportation vehicles, further preferably railway/railroad traffic. In the case of railway/railroad traffic, the term “unit for controlling transportation traffic” can also be referred to as “train-influencing unit”.

The communication network may preferably at least partly consist of an Ethernet network.

The functional unit may preferably comprise a control unit for monitoring and/or controlling the unit for monitoring and/or controlling transportation traffic. The functional unit is preferably connected to the at least one network access point by a wire connection and/or by means of a wireless connection. Further preferably the functional unit comprises an interface adapted to be connected to the at least one network access point.

The prediction unit may comprise a data interface adapted to be connected to at least one further network access point. By means of the data interface, the prediction unit is preferably adapted to capture communication telegrams, further preferably by filtering out communication telegrams relating to the at least one unit for monitoring and/or controlling transportation traffic.

Preferably the prediction unit comprises a computing unit adapted to perform a number of steps of a prediction algorithm, in particular by executing a number of steps defined by computer program code.

Preferably, a plurality of computing units is connected to the communication network by means of an interface each. Each computing unit may comprise the prediction unit. Alternatively or additionally, each computing unit may send the data to a cloud computing based prediction unit. The cloud computing based prediction unit may receive the data from the plurality of computing units connected to the network. The data is transferred from the plurality of computing units to the cloud computing based prediction unit over the communication network and/or over an external network, e.g. the World Wide Web.

According to a preferred embodiment of the system, the functional unit is a decentralized functional unit and the data is obtainable from a communication bus connecting the at least one decentralized functional unit to at least one superordinate control device of a railroad network. The superordinate control device may be part of an interlocking and further preferably formed by the interlocking. The communication bus forms at least part of a communication link between the superordinate control device of the railroad network and the decentralized functional unit.

According to a further preferred embodiment of the system, the data is obtainable from a communication bus of a superordinate control device. The superordinate control device may be part of an interlocking and further preferably formed by the interlocking. Further preferably, the prediction unit may be located at the interlocking.

Alternatively, a cloud based prediction unit is remotely located from the interlocking.

According to a further preferred embodiment, the at least one unit comprises at least one railroad element, preferably at least one railroad switch, at least one level crossing, preferably at least one railroad gate, at least one signaling device, at least one axle counter, at least one track circuit, and/or at least one point and/or line type train-influencing element. Preferably the unit for monitoring and/or controlling transportation traffic is the railroad switch. The railroad switch comprises a point machine for actuating the switch. The decentralized functional unit may be integrated into the point machine or connected to the point machine.

In a preferred enhancement of the embodiment, the railroad switch is configured to adopt a first switch state and a second switch state, wherein the data comprises a state information, representing one of the first and second switch state of the railroad switch, and a time information, representing a time point of adopting one of the first and second switch state by the railroad switch. The time information may be implemented by a time stamp. The switch state of the railroad switch may preferably be detected by the functional unit. Preferably, the functional unit is adapted to detect the switch state based on a control current applied to the point machine of the railroad switch. Further preferably, the time stamp may be created by the functional unit.

According to a further preferred enhancement, a transition duration of at least one occurring transition, the transition duration representing a duration of a transition between the first state and the second state, is determinable from the data. In particular, the transition duration may be determined from time information relating to one transition, namely one time information relating to the time point of adopting the first state and a further time information relating to the time point of adopting the second state. This preferred enhancement is advantageous since the transition duration is an important measure characterizing a condition of a railroad switch, in particular regarding an expected failure. The term “transition duration” is often referred to as “toggle duration” by the skilled person.

In a further preferred embodiment, a number of occurring transitions within a certain time interval, a type of at least one of the occurring transitions, a direction of at least one of the occurring transitions, and/or an occupancy information, representing an occurrence of a vehicle running over the railroad switch, is determinable from the data. In particular, this information is determinable by means of the prediction unit and/or a further computing unit connected to the communication network by means of an interface. Preferably, the type of the at least one of occurring transitions comprises: trailing, failure and/or success.

The afore-mentioned aspects (number, type, direction and occupancy) may be used in a prediction model for predicting the failure of the railroad switch.

In another preferred embodiment of the system according to the present invention, a mean transition value, preferably a moving average transition value, is determinable based on a plurality of transition duration values, each representing a transition duration of an elapsed transition of the railroad switch. The preferred moving average transition value may be calculated based on a time series of transition duration values relating to a series of occurred transitions, for example the last 5, 10 and/or 25 transitions.

In a preferred enhancement of the described embodiment, an outlier detection model score value, representing a condition of at least one occurring transition of the railroad switch, is determinable for the at least one occurring transition based on the moving average transition value, a difference between a transition duration of the occurring transition and the moving average transition value, and/or a difference between a maximum moving average transition value and a minimum moving average transition value of a sliding window.

Preferably each occurring transition for each railroad switch is scored by means of the outlier detection model (providing the outlier detection model score value) based on at least one of the afore-mentioned values (i.e. moving average transition value, difference between transition duration of the occurring transition and the moving average transition value, difference between maximum and minimum moving average transition value).

Further preferably, the outlier detection model scores each transition of a switch with respect to whether the transition represents a normal behavior or an abnormal behavior. Abnormal behavior in this sense means abnormal behavior which is not yet a failure of the switch. This is advantageous since the abnormal behavior detected by means of the outlier detection model may be used as an indication of an expected failure if the switch (prior to the failure).

Further preferably, the sliding window may comprise a series of subsequent moving average transition values, for example the last m moving average transition values.

In another preferred enhancement of the embodiment described above, at least one statistical measure is calculated based on the at least one outlier detection model score value, a failure information, relating to an elapsed failure of a transition of the at least one railroad switch, an occupancy information relating to a vehicle having run over the at least one railroad switch, a weather information relating to a past weather condition, a maintenance information relating to at least one maintenance of the at least one railroad switch, and/or a trailing information, relating to a past trailing of the at least one railroad switch of a predetermined time interval.

According to a further enhancement of the embodiment described above, the at least one statistical measure forms an input of a machine learning algorithm.

According to an even further enhancement of the embodiment described above, a condition score value, representing the condition of the railroad switch, is determined based on the at least one statistical measure by means of the machine learning algorithm, wherein a decision range of possible model score values is determined based on the machine learning algorithm, and wherein a failure of the railroad switch is expectable if the condition score value lies out of the decision range.

The invention further relates to a prediction unit for predicting a failure of at least one unit for monitoring and/or controlling transportation traffic, comprising: a network interface configured to be connected to a network access point of a communication network, wherein a functional unit dedicated to the at least one unit for monitoring and/or controlling transportation traffic is connected to a further network access point of the communication network, wherein the network interface is configured to capture data sent from the functional unit and/or received by the functional unit over the communication network, and wherein the prediction is based on the data.

The invention further relates to a method for predicting a failure of at least one unit for monitoring and/or controlling transportation traffic, comprising: exchanging data by means of a communication network having at least one network access point, wherein the at least one unit for monitoring and/or controlling transportation traffic has a dedicated functional unit being connected to the at least one network access point, and predicting the failure based on data sent from the functional unit and/or received by the functional unit over the communication network.

With regard to preferred embodiments, enhancements, details and preferred examples of the prediction unit or method for predicting a failure of at least one unit for monitoring and/or controlling transportation traffic, it may be referred to the respective description of the system features.

According to the invention it is preferred that the prediction of the unit for monitoring and/or controlling transportation traffic is solely based on data sent from and/or received by the functional unit over the communication network.

An exemplary embodiment of the present invention is described in greater detail with reference the drawing.

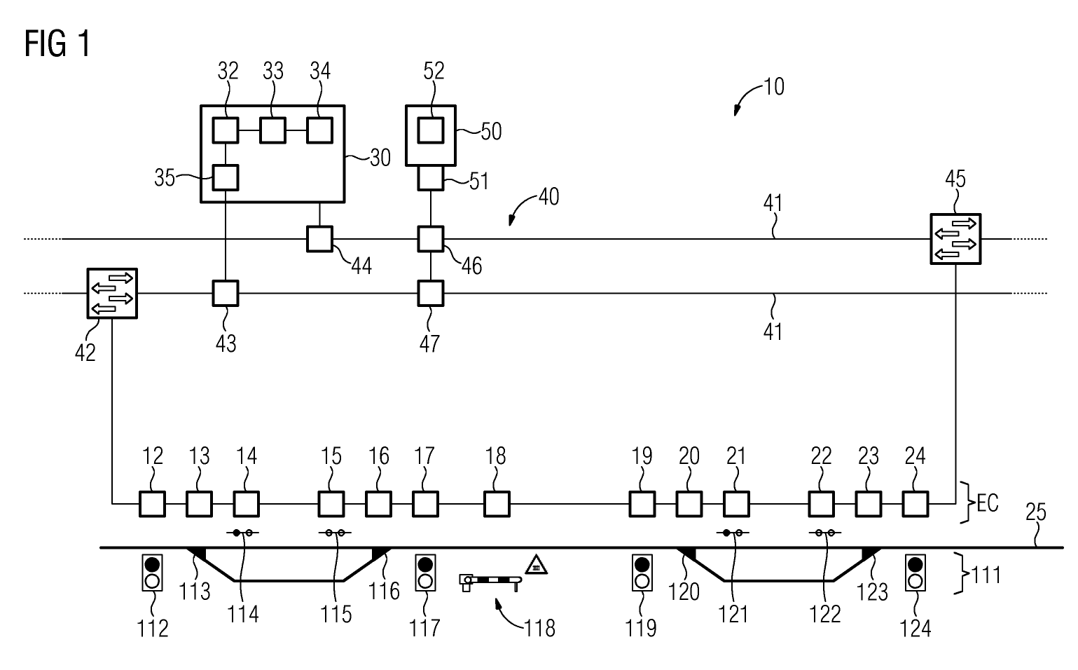

FIG. 1 shows a schematic view of the layout of a first embodiment of a system according to the invention and

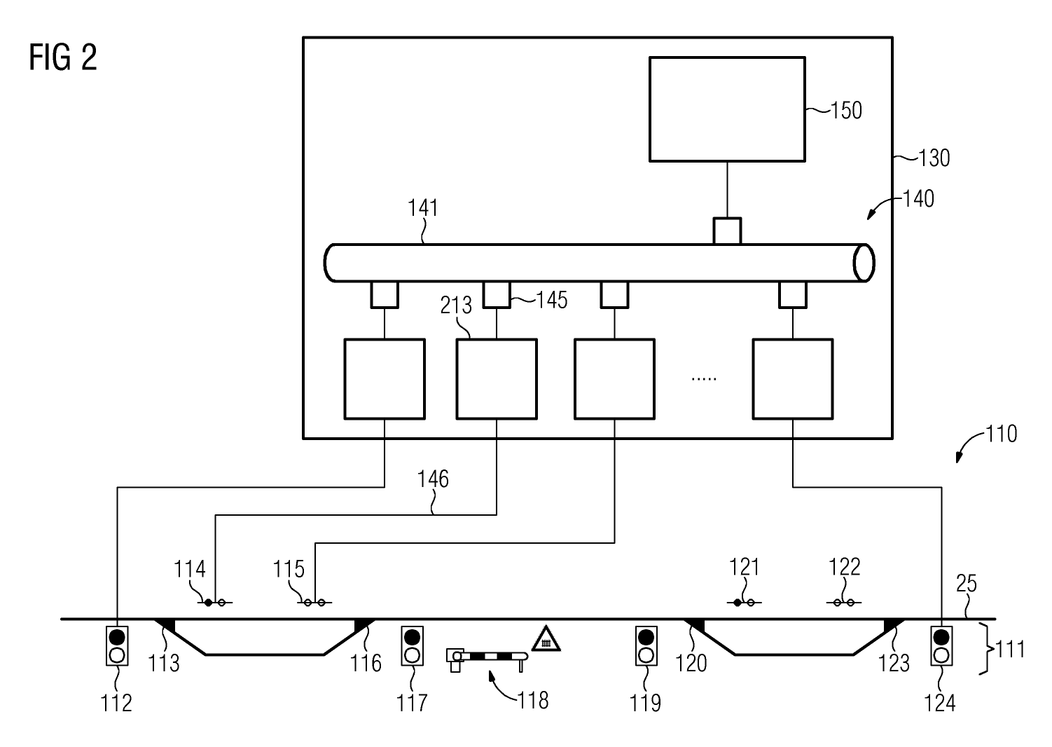

FIG. 2 shows a schematic view of the layout of a second embodiment of a system according to the invention.

The FIG. 1 shows a schematic view of the layout of a system 10 for controlling and/or monitoring transportation traffic. The system 10 comprises decentralized functional units 12-24 in form of element controllers arranged along a railroad network 25. Should a specific functional unit not be meant, the decentralized functional units will be referred to below by the general designation EC. These types of decentralized functional units EC are used to control and to monitor units 111 for monitoring and/or controlling transportation traffic. In the exemplary embodiment shown in FIG. 1, the transportation traffic is railway/railroad traffic. The system 10 has the functionality of predicting a failure of at least one of the units 111.

A number of these units 111 for monitoring and/or controlling transportation traffic are shown in the Figure. Railroad switches 113, 116, 120, 123, signaling devices 112, 117, 119, 124 and a level crossing 118 can be referred to as units for controlling transportation traffic (or train-influencing unit). Axle counters 114, 115, 121, 122 can be referred to as units for monitoring transportation traffic (or traffic-monitoring units).

The each decentralized functional unit EC is dedicated to a respective unit for monitoring and/or controlling transportation traffic 111.

For example the signaling device 112 is controlled and monitored by the decentralized functional unit 12. The decentralized functional unit 12 in such cases controls the display of the signaling device terms and guides or assists in monitoring functions respectively, such as the monitoring of the lamp current in the signaling device 112 for example.

As a further example the railroad switch 113 is controlled and monitored by the decentralized functional unit 13. The decentralized functional unit 13 in such cases controls the point machine of the railroad switch 113.

The system 10 further includes a communication network 40 having a number of network access points 42, 43, 44, 45, 46, 47. The communication network 40 comprises a communication bus 41. The communication bus 41 connects the at least one decentralized functional unit EC to at least one superordinate control device 30, preferably an interlocking, of the railroad network 25. Each decentralized functional unit EC (or the unit 111 controlled/monitored by it) has an address unique in the overall communication network, for example an IP address or a MAC address.

The superordinate control device 30 which, along with components not described in any greater detail here, includes a control center 32, an interlocking processor 33, an axle count processor 34 and a service/diagnosis unit 35, which are connected to the communication network via the network access points 43 and 44. As shown in FIG. 1, the decentralized functional units EC are connected to the communication network 40 via the network access points 42 and 45.

The system 10 further comprises a prediction unit 50 for predicting a failure of at least one of the units 111. The prediction unit 50 comprises a computing unit 52 adapted to perform a number of steps of a prediction algorithm, in particular by executing a number of steps defined by computer program code. The prediction unit 50 has a network interface 51 configured to be connected to the network access points 46 and 47 of the communication network 40. By means of the network interface 51 the prediction unit 50 may capture data from the communication bus 41.

The exemplary embodiment described in the following is directed to a method for predicting a failure of the railroad switch 113. However, the underlying idea behind this method is transferable to predicting failures of other units for monitoring and/or controlling transportation traffic.

The railroad switch 113 may adopt a first switch state in which the railroad switch has a first switch position and a second switch state in which the railroad switch has a second switch position. During the switching (also called toggle or transition), the railroad switch moves from the first position to the second position, i.e. a transition from the first state to the second state takes place. The time for the transition is called transition duration t_{trans,i}. The decentralized functional unit 13 sends out data (over the communication network 40) including switch relevant telegrams relating to actions performed by the railroad switch 113. The switch relevant telegrams are captured by the prediction unit 50.

The switch relevant telegrams include a state information, representing one of the first and second switch state of the railroad switch and a time information (time stamp), representing a time point of adopting the first or second switch state. A first time stamp represents the time point, when the railroad switch 113 adopts the first state. A second time stamp represents the time point, when the railroad switch 113 adopts the second state. From the difference of first and second time stamp, the transition duration is calculated.

From the switch relevant telegrams, further features of the railroad switch 113 are calculated at least partly by means of the prediction unit: For example the number of transitions Nₜᵣₐₙₛ occurring within a predetermined time interval are calculated. As a further example the type of the transition (e.g., trailing, failure, success) is determined from one or more transitions. Furthermore, the direction of the transition is determined for one or more transitions. Also, an occupancy information, representing an occurrence of a vehicle running over the railroad switch 113, is determinable from the switch relevant telegrams.

These calculated values and determined conditions of transitions are used in a prediction model for predicting the failure of the railroad switch:

For each transition i a moving average transition value Mat_{trans,i} is calculated from a number n of transition duration values t_{trans,i-n}, t_{trans,i-n+1}, . . . , t_{trans,i-1} representing the last n elapsed transitions. In other words, the transition durations t_{trans,i} form a time series. The moving average transition value MAt_{trans,i} represents the mean value of the last n values and the current value in the time series.

Each transition i is scored by means of an outlier detection model. Therefore, an outlier detection model score value Sᵢ is calculated for each transition i based on
the moving average transition value MAt_{trans,i},
a difference between the transition duration of the occurring transition t_{trans,i} and the moving average transition value MAt_{trans,i} and/or
a difference between a maximum moving average transition value max(MAt_{trans,1}, . . . , MAt_{trans,m}) and a minimum moving average transition value min (MAt_{trans,1}, . . . , MAt_{trans,m}) of a sliding window of m subsequent moving average transition values MAt_{trans,j}.

In particular, a number p of outlier detection model score values S_{1,i}, . . . , S_{p,i} (calculated for each transition i) are normalized.

From a past time interval t_{d} (e.g. the last ten days), the following features are gathered: all outlier detection model score values Sᵢ calculated during t_{d}, a failure information, relating to an elapsed failure of a transition of the at least one railroad switch during t_{d}, an occupancy information relating to a vehicle having run over the railroad switch during t_{d}, a weather information relating to a past weather condition during t_{d} and/or a trailing information, relating to a past trailing during t_{d}. From these gathered features, statistical measures Pₗ are calculated. A model score value is determined based on the statistical measures Pₗ. The statistical measures Pₗ are calculated at regular time points (e.g. every six hours) at least partly by means of the prediction unit 50.

The calculated statistical measures Pₗ are used to train a machine learning algorithm, i.e. the statistical measures form an input of the machine learning algorithm. For example, the machine learning algorithm learns from the last 40 steps (i.e. 10 days=40*6 hours) what the behavior of the railroad switch 113 was.

In particular, the machine learning algorithm is solely trained to problems derivated from lack of oil of the railroad switch 113 or adjustment of the railroad switch 113. In other words, the machine learning algorithm is preferably not trained for other problems such as a stone jammed between blades of the railroad switch.

Based on the statistical measure Pₗ, a condition score value C, representing the condition of the railroad switch 113, is calculated by means of the machine learning algorithm. Based on the machine learning algorithm, a decision range R of possible model score values is calculated. A failure of the railroad switch 113 is expectable (predicted) if the condition score value lies out of the decision range.

The FIG. 2 shows a schematic view of the layout of another system 110 for controlling and/or monitoring transportation traffic. The layout of the system 110 differs from the layout of the system 10 (depicted in FIG. 1). Similar or equal components of system 110 are referred to as by the same reference numerals as corresponding components of system 10.

A number of units 111 for monitoring and/or controlling transportation traffic are arranged along a railroad network 25. The units 111 are connected to a superordinate control device 130, in particular an interlocking.

The superordinate control device 130 which, along with components not described in any greater detail here, includes a communication network 140 having a communication bus 141, in particular an interlocking bus, as well as a number of functional units EC, wherein each functional unit is dedicated to one of the units 111 for monitoring and/or controlling transportation traffic. The functional units are connected to the communication network 140. For example, the functional unit 213 is connected to the communication network 140 by a network access point 145.

There is one connection to the superordinate control device 130 for each unit 111. In particular, the schematic representation of the embodiment shown in FIG. 2 depicts a connection 146 between the railroad switch 113 and the superordinate control device 130. The connection 146 is a four wire connection which connects the railroad switch 113 to the functional unit 213.

The functional unit 213 sends out data (over the communication network 140) including switch relevant telegrams relating to actions performed by the railroad switch 113. The switch relevant telegrams are captured by the prediction unit 150.

The data captured by the prediction unit 150 is corresponding to the data captured by the prediction unit 50 described with reference to FIG. 1. Accordingly, the prediction of a failure of the railroad switch 113 depicted in FIG. 2 corresponds to the prediction described with reference to FIG. 1.

1-14. (canceled)

15. A system for predicting a failure of at least one unit for monitoring and/or controlling transportation traffic, the system comprising:
a communication network having at least one network access point;
a functional unit connected to said at least one network access point and dedicated to the at least one unit for monitoring and/or controlling transportation traffic; and
a prediction unit configured to predict the failure of the at least one unit based on data sent from said functional unit and/or received by said functional unit over the communication network.

16. The system according to claim 15, wherein the functional unit is a decentralized functional unit and the data is obtainable from a communication bus connecting said at least one decentralized functional unit to at least one superordinate control device of a railroad network.

17. The system according to claim 15, wherein the data is obtainable from a communication bus of a superordinate control device.

18. The system according to claim 15, wherein the at least one unit is at least one railroad element selected from the group consisting of:
a railroad switch;
a level crossing;
a signaling device;
an axle counter;
a track circuit; and
a point and/or line type train-influencing element.

19. The system according to claim 18, wherein the level crossing is at least one railroad gate.

20. The system according to claim 15, wherein:
the at least one unit is a railroad switch configured to adopt a first switch state and a second switch state; and
the data comprises:
state information, representing one of the first and second switch states of the railroad switch; and
time information, representing a point in time when said railroad switch adopting one of the first and second switch states.

21. The system according to claim 20, wherein the data is suitable to enable a determination of a transition duration representing a duration of a transition between the first state and the second state.

22. The system according to claim 21, wherein the data enables a determination of one or more of the following:
a number of transitions occurring within a certain time interval;
a type of at least one of the occurring transitions;
a direction of at least one of the occurring transitions;
occupancy information, representing an occurrence of a vehicle running over said at least one railroad switch.

23. The system according to claim 21 wherein the data is suitable for determining a mean transition value based on a plurality of transition duration values, each representing a transition duration of an elapsed transition of said railroad switch.

24. The system according to claim 23, wherein the mean transition value is a moving average transition value.

25. The system according to claim 23, wherein the data is suitable for determining an outlier detection model score value, representing a condition of at least one occurring transition of the railroad switch, for the at least one occurring transition based on one or more of the following:
the moving average transition value;
a difference between a transition duration of the occurring transition and the moving average transition value;
a difference between a maximum moving average transition value and a minimum moving average transition value of a sliding window.

26. The system according to claim 25, wherein at least one statistical measure is calculated based on one or more of the following:
the at least one outlier detection model score value;
failure information, relating to an elapsed failure of a transition of said at least one railroad switch;
occupancy information, relating to a vehicle having run over said at least one railroad switch;
weather information, relating to a past weather condition;
maintenance information relating to a maintenance of said at least one railroad switch;
trailing information, relating to a past trailing of said at least one railroad switch of a predetermined time interval.

27. The system according to claim 26, wherein the at least one statistical measure forms an input of a machine learning algorithm.

28. The system according to claim 27, wherein:
the machine learning algorithm is configured to determine a condition score value, representing the condition of the railroad switch, based on the at least one statistical measure; and
the machine learning algorithm enables a decision range of possible model score values to be determined, wherein a failure of the railroad switch is to be expected if the condition score value lies outside the decision range.

29. A prediction unit for predicting a failure of at least one unit for monitoring and/or controlling transportation traffic, the prediction unit comprising:
a network interface to be connected to a network access point of a communication network, wherein a functional unit dedicated to the at least one unit for monitoring and/or controlling transportation traffic is connected to a further network access point of the communication network;
said network interface being configured to capture data sent from the functional unit and/or received by the functional unit over the communication network; and
the prediction unit being configured to predict a failure of at least one unit based on the data.

30. A method for predicting a failure of at least one unit for monitoring and/or controlling transportation traffic, the method comprising:
exchanging data by way of a communication network having at least one network access point, wherein the at least one unit for monitoring and/or controlling transportation traffic has a dedicated functional unit that is connected to the at least one network access point; and
predicting the failure of the at least one unit based on data sent from the functional unit and/or received by the functional unit over the communication network.
